(19) United States
(12) Patent Application Publication
(10) Pub. No.: US 2022/0358512 A1
(43) Pub. Date: Nov. 10, 2022

(54) SMART AUTONOMOUS STORE ENTRY SYSTEM

(71) Applicant: AiFi Corp, Santa Clara, CA (US)

(72) Inventors: Steve Gu, Santa Clara, CA (US); Ying Zheng, Santa Clara, CA (US); Joao Falcao, Santa Clara, CA (US)

(73) Assignee: AiFi Corp, Santa Clara, CA (US)

(21) Appl. No.: 17/314,050

(22) Filed: May 7, 2021

(51) Int. Cl. G06Q 20/40; G06Q 20/18; G06Q 30/02

(52) U.S. Cl. CPC G06Q 20/40145; G06Q 20/18; G06Q 30/0271

(57) ABSTRACT

This application relates to systems, methods, devices, and other techniques for a smart autonomous store entry system that can be utilized within a retail environment. This system with doors, cameras, and sensors is designed to have many functions within a store with identification system and sometimes can be utilized in a store with or without human cashier.

### BACKGROUND OF THE INVENTION

This application relates to systems, methods, devices, and other techniques for a smart autonomous store entry system that can be utilized within a retail environment.

Methods and apparatus for using cameras in a retail store for monitoring products and customers are well known and in practices. However, systems, methods, devices, and other techniques for a system for a smart autonomous store that can be utilized within a retail environment need is new and could be combined with recently developed AI and machine learning and sensor technology.

Therefore, it is desirable to have systems, methods, devices, and other techniques for a smart autonomous store entry system that can be utilized within a retail environment.

### SUMMARY OF THE INVENTION

This application relates to systems, methods, devices, and other techniques for a smart autonomous store entry system that can be utilized within a retail environment.

This system with doors, cameras, and sensors is designed to have many functions within a store with identification system and sometimes can be utilized in a store with or without human cashier.

In some embodiments, the invention is related to a smart autonomous store, comprises:a server; an authentication device coupled to the server, wherein the authentication device is configured to obtain personal information from a user's identifying item when the user presents the user's identifying item within an area near entry of the smart autonomous store, wherein boundary of the area is invisible to a human eye, wherein the authentication device is configured to transmits the personal information to a server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained; a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user; an entry door couple to the smart autonomous store server, wherein the entry door is configured to open and allow the user to enter when the authentication of the personal information from the server; and

a manager terminal coupled to the server, wherein the manager terminal is manned by a person during a pre-determined working time, wherein the manager terminal is, notified when the user presents the user's identifying item.

In some embodiments, the pre-determined time is from 8 am to 5 pm.

In some embodiments, the promotional information is configured to meet the user's personal taste.

In some embodiments, the invention is related to a smart autonomous store, comprises: a server; an authentication device coupled to the server, wherein the authentication device is configured to obtain personal information from a user's identifying item when the user presents the user's identifying item within an area near entry of the smart autonomous store, wherein boundary of the area is visible to a human eye; wherein the authentication device is configured to transmits the personal information to a server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained; a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user; a set of entry doors couple to the smart autonomous store and the server, wherein the set of entry doors are configured to have vision sensors attached to the set of entry doors, wherein the vision sensors are configured to identify one door that is closest to the user, wherein the one of the entry door is configured to open when the authentication of the personal information from the server; and a manager terminal coupled to the server, wherein the manager terminal is manned by a person during a pre-determined working time, wherein the manager terminal is notified when the user presents the user's identifying item.

In some embodiments, the pre-determined time is from 8 am to 5 pm.

In some embodiments, the promotional information is configured to meet the user's personal taste.

In some embodiments, the invention is related to a smart autonomous store, comprises: a server; an authentication device coupled to the server, wherein the authentication device is configured to obtain personal information from a user's identifying item when the user presents the user's identifying item within an area near entry of the smart autonomous store, wherein boundary of the area is invisible to a human eye, wherein the authentication device is configured to transmits the personal information to a server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained, wherein the user that presented the user's identifying item can leave the store using an autonomous checkout system, wherein the autonomous checkout system is configure with cameras, sensors and other systems; a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user; an entry door couple to the smart autonomous store and the server, wherein the entry door is configured to open and allow the user to enter when the authentication of the personal information from the server; a manager terminal coupled to the server, wherein the manager terminal is manned by a person during a pre-determined working time, wherein the manager terminal is notified when the user presents the user's identifying item, wherein the manager terminal is configured to process checkout process manually when another user does not present the another user's identifying information; and a control gate coupled to the server, wherein the control gate separates an age-restricted area from rest of the smart shop, wherein the control gate is configured to restrict access to the age-restrict area unless the manager terminal is manned by a person and the personal information shows the user is older than the legal age to access the age-restricted area.

In some embodiments, the pre-determined time is from 8 am to 5 pm.

In some embodiments, the promotional information is configured to meet the user's personal taste.

These and other aspects, their implementations and other features are described in details in the drawings, the description and the claims.

### BRIEF DESCRIPTION OF THE DRAWINGS

FIG. 2 shows an example of a smart autonomous store entry system.

FIG. 2 shows another example of a smart autonomous store entry system.

FIG. 3 shows a third example of a smart autonomous store entry system.

### DETAILED DESCRIPTION OF THE INVENTION

FIG. 1 shows an example of a smart autonomous store entry system.

In some implementations, the a smart autonomous store entry system for a smart autonomous store 100 comprises: a server 105; an authentication device 110 coupled to the server, wherein the authentication device 110 is configured to obtain personal information from a user's 130 identifying item 135 when the user presents the user's identifying item 135 within an area near entry of the smart autonomous store 100, wherein boundary of the area 140 is invisible to a human eye, wherein the authentication device 110 is configured to transmits the personal information to a server 105, wherein the authentication device 110 is configured to receive authentication of the personal information from the server 105, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server 105 is configured to regard the user as a VIP member after the personal information are obtained; a display 115 coupled to the server 105, wherein the display 115 is configured to be viewable to persons outside of the smart autonomous store 100, wherein the display 115 is configured to display promotional information specialized for the user after the authentication of the personal information from the server, wherein the display is configured to display a phrase of “welcome” in language pre-selected by the user; an entry door 120 couple to the smart autonomous store 100 and the server 105, wherein the entry door 120 is configured to open and allow the user to enter when the authentication of the personal information from the server 105; and a manager terminal 125 coupled to the server 105, wherein the manager terminal 125 is manned by a person during a pre-determined working time, wherein the manager terminal 125 is notified when the user presents the user's identifying item 135.

In some embodiments, the pre-determined time is from 8 am to 5 pm.

In some embodiments, the promotional information is configured to meet the user's personal taste.

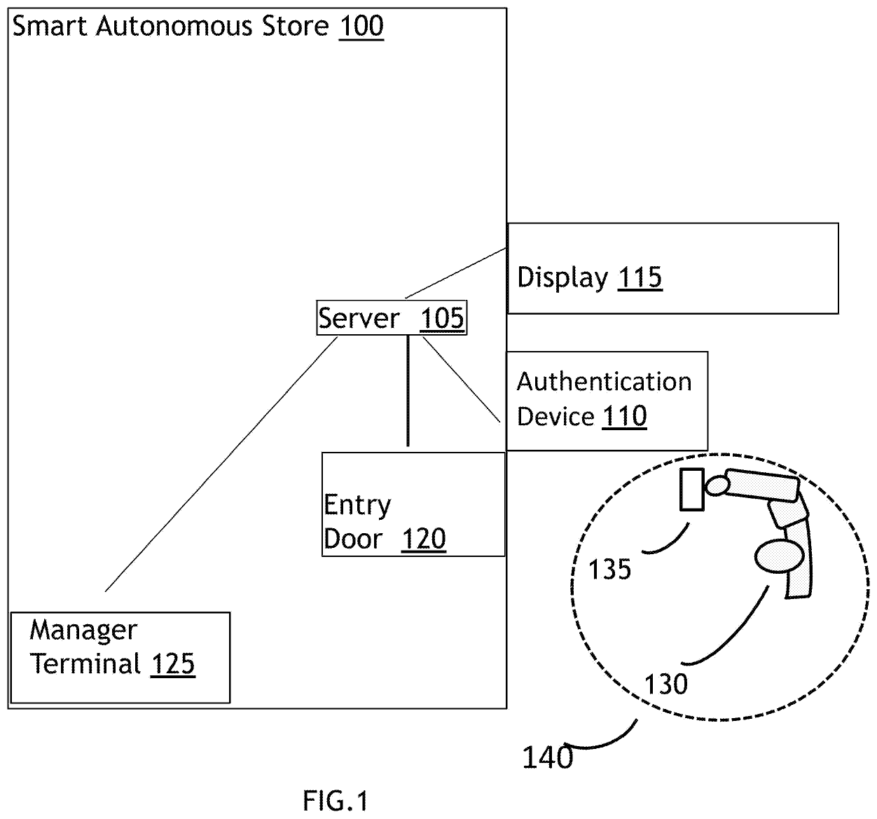

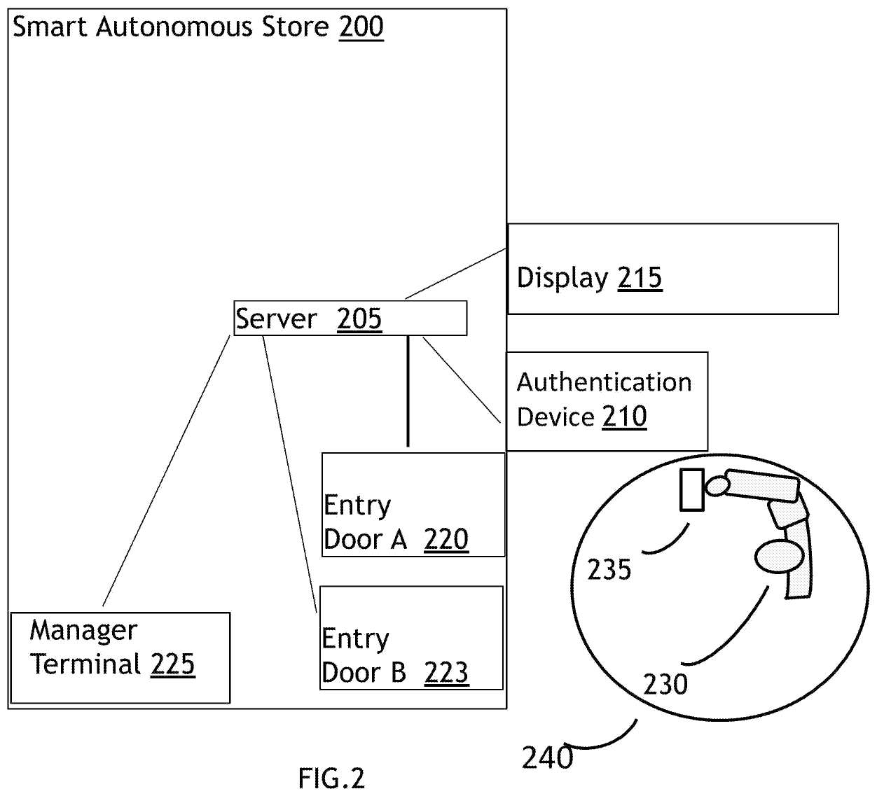

FIG. 2 shows another example of a smart autonomous store entry system.

In some implementations, the a smart autonomous store entry system for a smart autonomous store 200 comprises: a server 205; an authentication device 210 coupled to the server 205, wherein the authentication device 210 is configured to obtain personal information from a user 230's identifying item 235 when the user 230 presents the user's identifying item 235 within an area near entry of the smart autonomous store, wherein boundary 240 of the area is visible to a human eye; wherein the authentication device 235 is configured to transmits the personal information to a server 205, wherein the authentication device 235 is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server 205 is configured to regard the user as a VIP member after the personal information are obtained; a display 215 coupled to the server, wherein the display 215 is configured to be viewable to persons outside of the smart autonomous store, wherein the display 215 is configured to display promotional information specialized for the user after the authentication of the personal information from the server, wherein the display 215 is configured to display a phrase of “welcome” in language pre-selected by the user; a set of entry doors (Entry Door A 220 and Entry Door B 223) couple to the smart autonomous store and the server, wherein the set of entry doors are configured to have vision sensors attached to the set of entry doors, wherein the vision sensors are configured to identify one door that is closest to the user, wherein the one of the entry door is configured to open when the authentication of the personal information from the server; and a manager terminal 225 coupled to the server, wherein the manager terminal 225 is manned by a person during a pre-determined working time, wherein the manager terminal is notified when the user presents the user's identifying item 235.

In some embodiments, the pre-determined time is from 8 am to 5 pm.

In some embodiments, the promotional information is configured to meet the user's personal taste.

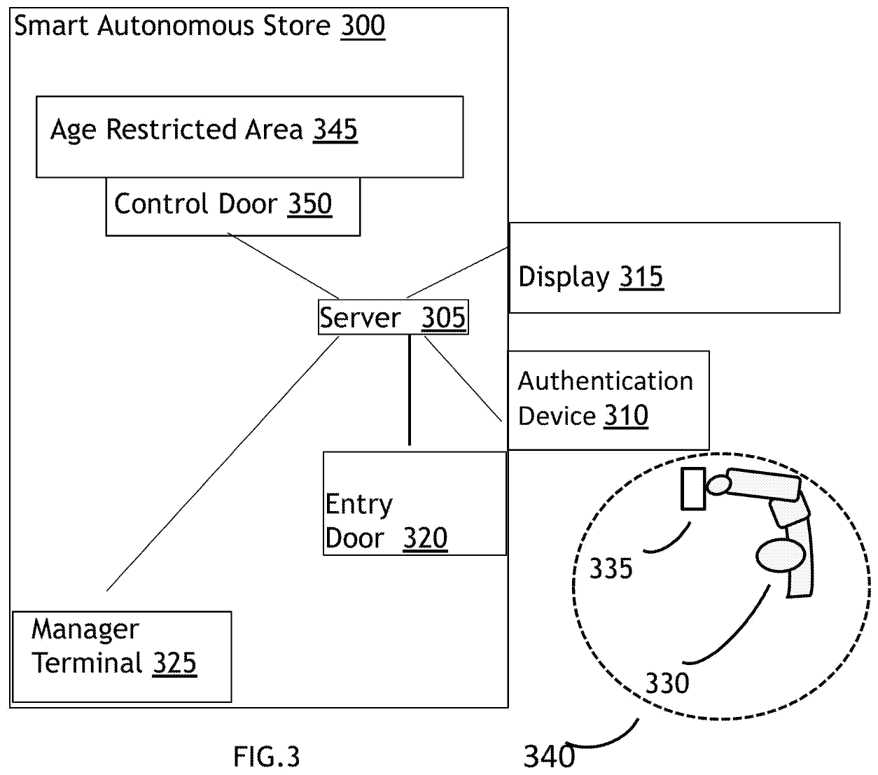

FIG. 3 shows a third example of a smart autonomous store entry system.

In some implementations, the a smart autonomous store entry system for a smart autonomous store 300 comprises: a server 305; an authentication device 310 coupled to the server, wherein the authentication device 310 is configured to obtain personal information from a user's 330 identifying item 335 when the user presents the user's identifying item 335 within an area near entry of the smart autonomous store 300, wherein boundary of the area 340 is invisible to a human eye, wherein the authentication device 310 is configured to transmits the personal information to a server 305, wherein the authentication device 310 is configured to receive authentication of the personal information from the server 305, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server 305 is configured to regard the user as a VIP member after the personal information are obtained; a display 315 coupled to the server 305, wherein the display 315 is configured to be viewable to persons outside of the smart autonomous store 300, wherein the display 315 is configured to display promotional information specialized for the user after the authentication of the personal information from the server, wherein the display is configured to display a phrase of “welcome” in language pre-selected by the user; an entry door 320 couple to the smart autonomous store 300 and the server 305, wherein the entry door 320 is configured to open and allow the user to enter when the authentication of the personal information from the server 305;

a manager terminal 325 coupled to the server 305, wherein the manager terminal 325 is manned by a person during a pre-determined working time, wherein the manager terminal 325 is notified when the user presents the user's identifying item 335; and a control gate 350 coupled to the server, wherein the control gate separates an age-restricted area 345 from rest of the smart autonomous store 300, wherein the control gate 350 is configured to restrict access to the age-restrict area 345 unless the manager terminal is manned by a person and the personal information shows the user is older than the legal age to access the age-restricted area 345.

In some embodiments, the pre-determined time is from 8 am to 5 pm.

In some embodiments, the promotional information is configured to meet the user's personal taste.

1. A smart autonomous store, comprises:
a server;
an authentication device coupled to the server, wherein the authentication device is configured to obtain personal information from a user's identifying item when the user presents the user's identifying item within an area near entry of the smart autonomous store, wherein boundary of the area is invisible to a human eye, wherein the authentication device is configured to transmits the personal information to the server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained;
a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user;
an entry door couple to the smart autonomous store and the server, wherein the entry door is configured to open and allow the user to enter when the authentication of the personal information from the server; and
a manager terminal coupled to the server, wherein the manager terminal is manned by a person during a pre-determined working time, wherein the manager terminal is notified when the user presents the user's identifying item.

2. A smart autonomous store of claim 1, wherein the pre-determined time is from 8 am to 5 pm.

3. A smart autonomous store of claim 1, wherein the promotional information is configured to meet the user's personal taste.

4. A smart autonomous store, comprises:
a server;
an authentication device coupled to the server, wherein the authentication device is configured to obtain personal information from a user's identifying item when the user presents the user's identifying item within an area near entry of the smart autonomous store, wherein boundary of the area is visible to a human eye; wherein the authentication device is configured to transmits the personal information to the server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained;
a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user;
a set of entry doors couple to the smart autonomous store and the server, wherein the set of entry doors are configured to have vision sensors attached to the set of entry doors, wherein the vision sensors are configured to identify one door that is closest to the user, wherein the one of the entry door is configured to open when the authentication of the personal information from the server; and
a manager terminal coupled to the server, wherein the manager terminal is manned by a person during a pre-determined working time, wherein the manager terminal is notified when the user presents the user's identifying item.

5. A smart autonomous store of claim 4, wherein the pre-determined time is from 8 am to 5 pm.

6. A smart autonomous store of claim 4, wherein the promotional information is configured to meet the user's personal taste.

7. A smart autonomous store, comprises:
a server;
an authentication device coupled to the server, wherein the authentication device is configured to obtain personal information from a user's identifying item when the user presents the user's identifying item within an area near entry of the smart autonomous store, wherein boundary of the area is invisible to a human eye, wherein the authentication device is configured to transmits the personal information to the server, wherein the authentication device is configured to receive authentication of the personal information from the server, wherein the user's identifying item can be an phone, a credit card, a membership card, a QR code or the user's biometrics information, wherein the user's biometrics information could come from palm scan, finger scan, Iris scan, or facial recognition scan, wherein the phone is configured to have an application with blue tooth or wifi-enabled verification, wherein the server is configured to regard the user as a VIP member after the personal information are obtained, wherein the user that presented the user's identifying item can leave the store using an autonomous checkout system, wherein the autonomous checkout system is configure with cameras, sensors and other systems;
a display coupled to the server, wherein the display is configured to be viewable to persons outside of the smart autonomous store, wherein the display is configured to display promotional information specialized for the user after the authentication of the personal information from the server, wherein the display is configured to display a phrase of “welcome” in language pre-selected by the user,
an entry door couple to the smart autonomous store and the server, wherein the entry door is configured to open and allow the user to enter when the authentication of the personal information from the server;
a manager terminal coupled to the server, wherein the manager terminal is manned by a person during a pre-determined working time, wherein the manager terminal is notified when the user presents the user's identifying item, wherein the manager terminal is configured to process checkout process manually when another user does not present the another user's identifying information; and
a control gate coupled to the server, wherein the control gate separates an age-restricted area from rest of the smart autonomous store, wherein the control gate is configured to restrict access to the age-restrict area unless the manager terminal is manned by a person and the personal information shows the user is older than the legal age to access the age-restricted area.

8. A smart autonomous store of claim 7, wherein the pre-determined time is from 8 am to 5 pm.

9. A smart autonomous store of claim 7, wherein the promotional information is configured to meet the user's personal taste.
